(19) United States
(12) Patent Application Publication
(10) Pub. No.: US 2004/0240878 A1
(43) Pub. Date: Dec. 2, 2004

(54) CAMERA USING A LIGHT GUN TO PROVIDE A PHOTOGRAPHIC POSITION

(76) Inventor: Cheng-Kuang Tseng, I-Lan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,100

(22) Filed: Apr. 14, 2004

(30) Foreign Application Priority Data
May 29, 2003 (TW) 092114632

(51) Int. Cl. G03B 13/02

(52) U.S. Cl. 396/431

(57) ABSTRACT

A camera includes a lens for capturing an image in an image area, a light gun for projecting a light spot at the edge of the image area, and a light gun switch for selectively turning on the light gun in order to project the light spot. Wherein, when the light spot is projected, a person having their picture taken can see the edge of the image area.

### BACKGROUND OF INVENTION

1. Field of the Invention

The present invention relates to a camera, and more specifically, to a camera using beam projection to target a subject in its image area.

2. Description of the Prior Art

The word “camera” refers to a general type of equipment used to record images. Both traditional film cameras and modern digital cameras are widely used in daily life. When taking pictures with a camera, generally the position of the subject or the object in the view to be shot deeply influences the result. However, in traditional photography, the subject must be directed by the photographer to move to the correct position. The subject is unable to see the size of the image area or the composition of the picture, and thus completely relies on the photographer's technique.

Generally speaking, if the subject wants to directly control the resulting picture, s/he is required to communicate with the person taking the picture to setup the viewfinder and picture composition. The communication is often performed by the subject first standing at the position of the photographer to simulate shooting and to determine the correct position where the subject should stand or the object should be placed. The camera is then handed over to the photographer, and the subject moves to the correct position. Such kind of setup is ineffective and inefficient. Furthermore, the result desired by the subject is often not realized. Problems such as improper positioning, and different viewfinder results due to the photographer's familiarity with the camera may occur, lowering the quality of the resulting picture. In the case of a traditional camera, the result is only known after the film is developed, which causes a wasted film in the case that the picture quality is not sufficient. Even in the case of a digital camera, where the composition of the picture is shown on an LCD panel, the subject can only check the result after shooting to decide whether to keep the picture or to delete it. The requirements of the subject are still not fulfilled.

As mentioned above, when using a conventional camera, the subject cannot directly handle the composition of the picture and must rely on the photographer's technique or communicate with the photographer to indirectly setup the picture.

### SUMMARY OF INVENTION

It is therefore a primary objective of the present invention to provide a camera equipped with a light gun in order that a subject of the photo can see the image area of the camera, in order to ensure the quality of the picture and solve the problems mentioned above.

Briefly summarized, a camera includes a lens for capturing an image in an image area, a light gun for projecting a light spot on the edge of the image area, and a light gun switch for turning on the light gun selectively in order to project the light spot. Wherein, when the light spot is projected, the subject can see the edge of the image area.

The camera according to the present invention has a light gun installed inside it. According to other requirements, a motor or a connecting rod can also be installed. When a photographer adjust the lens to change the image area, the motor or the connecting rod adjusts the light gun accordingly to have the light gun show the image area, which can be seen by the subject.

The camera according to the present invention further includes a shutter button connected to the light gun switch. When taking a picture, the photographer presses the shutter button to a first stage to focus on the object. A preferred embodiment of the present invention is to control the light gun switch at the first stage of the shutter button in order to turn on the light gun. The light gun is switched off at a second stage of the shutter button and the camera will take the picture after the light spot is removed.

Since the camera according to the present invention includes a light gun, the light spot projected by the light gun indicates the image area, allowing the subject to move to the correct position and fulfill this is her personal requirements for the photograph.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an external view of a camera according to the present invention.

FIG. 2 illustrates an internal view of the rear of the camera.

FIG. 3 illustrates an internal view of the front of the camera.

FIG. 4 illustrates the operation of the camera.

FIG. 5 illustrates the frame lines and the light spots of the camera when shooting a far object.

FIG. 6 illustrates the frame lines and the light spots of the camera when shooting a close object.

### DETAILED DESCRIPTION

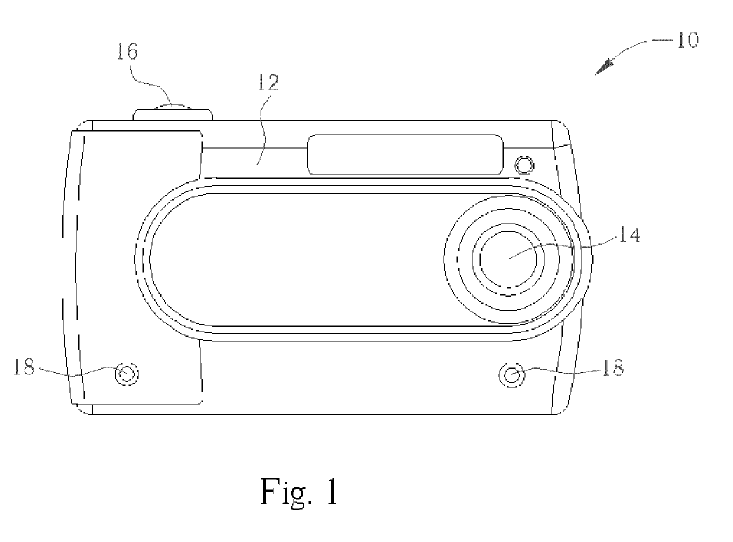

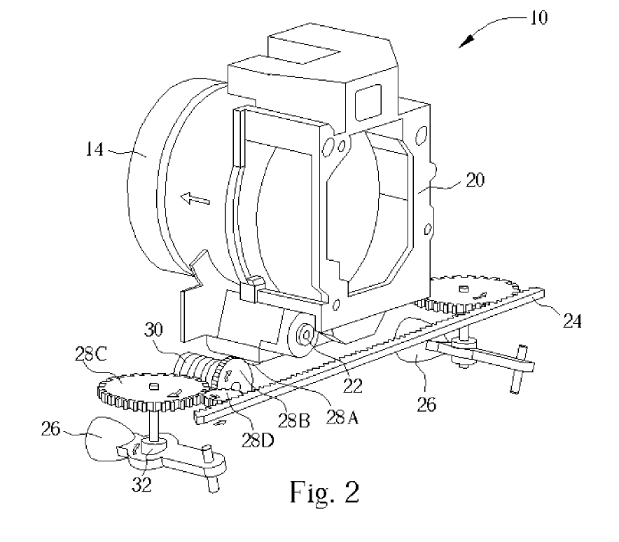

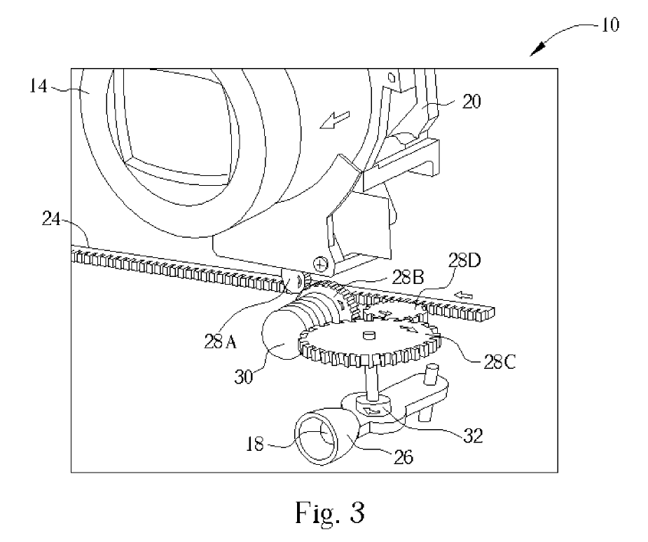

Please refer to FIG. 1, FIG. 2, and FIG. 3. FIG. 1 shows an external view of a camera 10 according to the present invention. FIG. 2 shows an internal view of the rear of the camera 10, and FIG. 3 shows an internal view of the front of the camera 10. In the following description, the position of each device of the camera 10 is described from the aspect of the person taking the picture, also referred to as the photographer. As shown in FIG. 1, the camera 10 includes a housing 12, a zooming lens 14 on the front left side of the camera 10, a shutter button 16 on the upper right side of the housing 12, a light gun switch (not shown) connected to the shutter button 16, and two light guns 18 located respectively on the bottom left and bottom right sides. As shown in FIG. 2 and FIG. 3, the camera 10 further includes a shooting module 20, a step motor 22 connected to the zooming lens 14, a rack 24 connected to the step motor 22, two light gun connecting rods 26, a plurality of gears 28A-28D and a screw rod 30. The shooting module 20 is connected to the zooming lens 14 and the step motor 22, and includes mechanical devices such as a shutter and a film advance and electronic devices such as a control circuit, an auto focusing device, and a flash to provide the camera 10 functions of focusing, viewfinding, and shooting. Since these parts are not the central theme of the present invention and are widely known by persons skilled in the art, a further description is hereby omitted. The step motor 22 (under the shooting module 20), the rack 24, the gears 28A-28D, and the screw rod 30 are for assisting the light guns 18 to project a light spot in the proper position. Using the step motor 22 installed on the zooming lens 14, accompanied with the rotation of the gears 28A-28D, the light gun connecting rods 26 adjust the projection position of the light spot according to the movement of the zooming lens 14, in order to determine the viewfinding frame lines of the camera.

The light guns 18 of the camera 10 are described as follows. The zooming lens 14 can be adjusted when taking a picture. When shooting a near object, the step motor 22 pulls the zooming lens 14 forward so that the gear 28A rotates clockwise and the gear 28B rotates counterclockwise, as shown by the arrow in FIG. 3. The screw rod 30 in front of the gear 28B rotates the gear 28C clockwise so that a cam 32 under the gear 28C rotates clockwise to pull the light gun connecting rod 26 to swing upwards at an angle to the left. This design takes the rear part of the light gun connecting rod 26 as a rotation center, which slants at an angle, wherein the angle equals to the angle of elevation adjusted from a farther depth of field to a closer depth of field. This allows the photographer and the subject to handle the image area. On the other hand, as shown by the arrow in FIG. 2, when the light gun connecting rod 26 on the left side swings, the gear 28C will rotate the gear 28D counterclockwise so that the rack is pulled toward the light gun connecting rod 26 on the right side, and a light spot is positioned going forward according to the forward movement of the zooming lens.

In the preferred embodiment of the present invention, as shown in FIG. 1, the switching of the light guns 18 can be automatic or manual. In the case of automatic switching, the light gun switch is connected to the shutter button 16 and is controlled by the shutter button 16. In order to prevent the light spot from influencing the quality of the picture, the light guns 18 are switched off before the shutter is opened. The operating steps are as follows. When the photographer aims on a far object or a close object, the light guns 18 adjust the projection of the light spot according to the distance between the object and the camera. The photographer then presses the shutter button 16 to a first stage for the shooting module 14 to focus on the subject. The light guns 18 project the light spots to indicate the viewfinding frame lines so that the subject can see the image area. Subsequently, when the photographer presses the shutter button 16 to a second stage, the control circuit switches off the light guns 0.1 sec. before the shutter is opened to eliminate the light spot.

The internal structure of the camera 10 (as shown in FIG. 2 and FIG. 3) is according to a preferred embodiment of the present invention. In other embodiments, different designs according to different ratios of revolution and numbers of gear teeth are possible. For instance, the gear ratio and the angle of rotation of the cam can be adjusted, or if the motor drives the gears in a different direction, the rotating direction of the screw rod can also be adjusted. In addition to the mechanical design, other technologies well known by people skilled in the art to control the angle of the light guns according to the viewfinder with circuits or other devices are possible. Furthermore, the number of the light guns can be determined according to different requirements. Therefore, in another embodiment of the present invention, the camera has only one light gun in the middle of the front of the camera. The camera further includes a beam splitter for splitting light generated by the light gun, so that the light gun can also project two light spots to determine the image area.

In the preferred embodiment of the present invention, the light guns 18 are high brightness light emitting diodes (LED). The light generated by the light guns 18 is reflected and converged into two light spots on the two sides of the object. In order to prevent over convergence harmful to the photographer, the projection angle of the reflected beam can be controlled to be less than or equal to 0.5 degrees.

Please note that the light guns 18 and the related mechanism for controlling the light guns 18, as mentioned above, are applied to a camera. However, the light guns 18 and the related control mechanism according to the present invention can be implemented on any image capturing device to provide these helpful light spots for indicating edges of an image area currently targeted by the image capturing device.

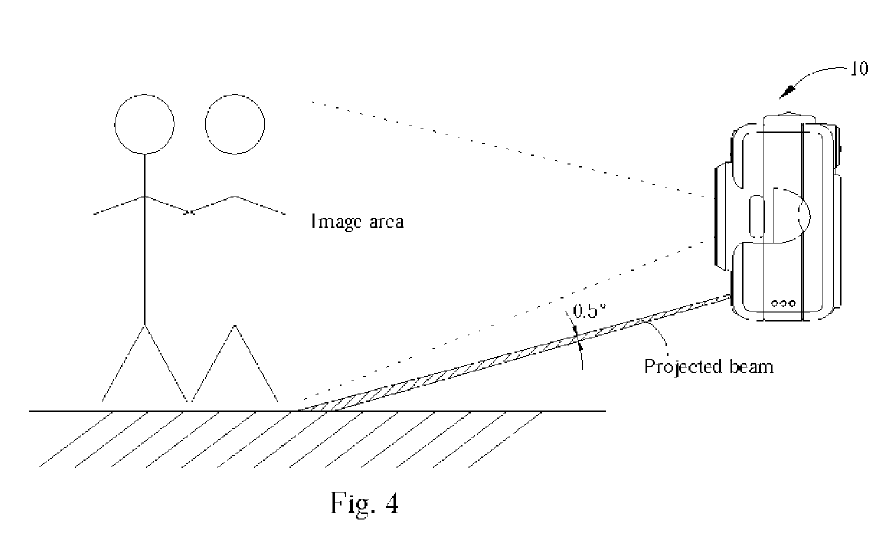

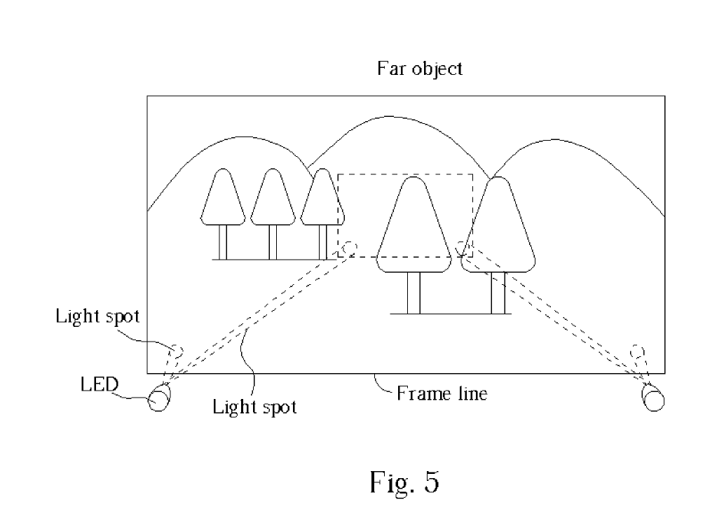

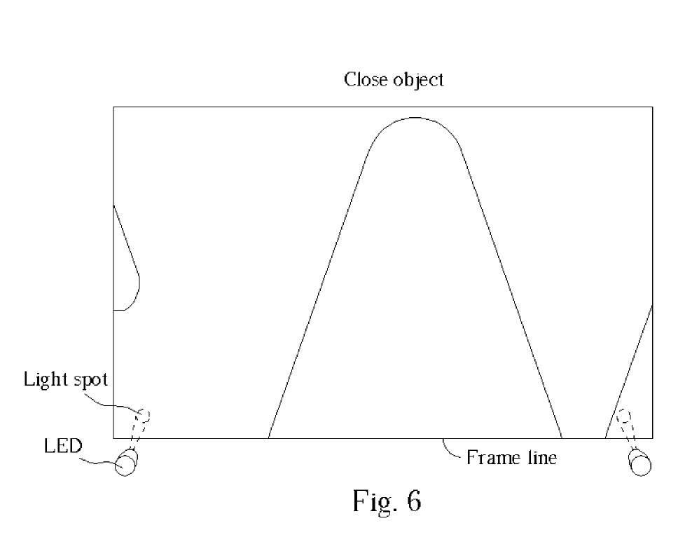

Please refer to FIG. 4 showing the operation of the camera 10. Additionally, FIG. 5 and FIG. 6 show the frame lines and the light spots of the camera 10 when shooting a far object or a close object respectively. As shown in FIG. 4, when the photographer is using the camera 10, the angle of the beam is 0.5 degrees to prevent from harm to the subject's eyes. The light spots are on the lower left and lower right side of the frame lines to indicate to the subject the image area. As shown in FIG. 5, when shooting a far object, the image area determined by the light spots projected by the light guns 18 is larger. When the photographer changes to shoot a close object, the step motor 22 connected to the zooming lens 14 drives the light guns 18 to change the projecting direction. In this situation, the projected beam moves to the middle part of the frame and stretches backwards to determine the frame, indicated by the dotted box in FIG. 5. The zoomed in frame is also shown in FIG. 6.

Briefly summarized, the camera according to the present invention includes light guns installed inside. Furthermore, the projecting direction of the light guns is changed according to the movement of the zooming lens, so that the image area is determined by the projected light spots. Using a camera with light guns on two sides for example, if the camera has an optical focusing lens, an additional step motor can be used to control the light spot projection. If the camera has a digital focusing lens, a connecting rod can instead be used to control the light spot projection. In addition, the light guns can be designed to function with a two-stage shutter button, so that when the shutter button is pressed to the first stage, the light guns will be turned on, and when the shutter button is pressed to the second stage, the light guns will be turned off. In this way, the light spots are removed before the shutter is opened preventing the light spots from interfering with the picture.

In contrast to the prior art, the camera according to the present invention indicates to a subject the size of the image area so that the subject can find the correct position to stand at. Furthermore the subject is now capable to directly handle the photo setup and ensure the quality of the picture rather than indirectly setting up the photo by communicating with the photographer.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A camera comprising:
a lens for capturing an image in an image area;
a light gun for projecting a light spot at the edge of the image area; and
a light gun switch for selectively turning on the light gun in order to project the light spot;
wherein when the light spot is projected, a subject can see the edge of the image area.

2. The camera of claim 1 further comprising a gear and a connecting rod installed between the lens and the light gun for adjusting the projecting position of the light spot.

3. The camera of claim 2 further comprising a motor for driving the gear and the connecting rod.

4. The camera of claim 1 wherein the light gun is a high brightness light emitting diode (LED).

5. The camera of claim 1 further comprising two light guns installed substantially toward the same side with the lens.

6. The camera of claim 1 further comprising a shutter and a shutter button, wherein the light gun switch is the shutter button, a first stage of the shutter button for turning on the light gun to project the light spot, and a second stage of the shutter button for turning off the light gun and opening the shutter so that light can pass through the lens.

7. The camera of claim 1 wherein the lens is a zooming lens which can selectively change the size of the image area, and the light gun changes its position according to the size of the image area in order to keep the light spot projected at the edge of the image area.

8. An image capturing device comprising:
a lens for capturing an image in an image area;
a light gun for projecting a light spot at the edge of the image area; and
a light gun switch for selectively turning on the light gun in order to project the light spot;
wherein when the light spot is projected, a subject can see the edge of the image area.

9. The image capturing device of claim 8 further comprising a gear and a connecting rod installed between the lens and the light gun for adjusting the projecting position of the light spot.

10. The image capturing device of claim 9 further comprising a motor for driving the gear and the connecting rod.

11. The image capturing device of claim 8 wherein the light gun is a high brightness light emitting diode (LED).

12. The image capturing device of claim 8 further comprising two light guns installed substantially toward the same side with the lens.

13. The image capturing device of claim 8 further comprising a shutter and a shutter button, wherein the light gun switch is the shutter button, a first stage of the shutter button for turning on the light gun to project the light spot, and a second stage of the shutter button for turning off the light gun and opening the shutter so that light can pass through the lens.

14. The image capturing device of claim 8 wherein the lens is a zooming lens which can selectively change the size of the image area, and the light gun changes its position according to the size of the image area in order to keep the light spot projected at the edge of the image area.
